(19) United States
(12) Patent Application Publication
(10) Pub. No.: US 2025/0218007 A1
(43) Pub. Date: Jul. 3, 2025

(54) METHOD FOR CORRECTING DIGITAL SUBTRACTION ANGIOGRAPHY IMAGE, COMPUTER DEVICE AND STORAGE MEDIUM

(71) Applicant: Shanghai United Imaging Healthcare Co., Ltd., Shanghai (CN)

(72) Inventors: Liang Yue, Shanghai (CN); Yang Hu, Shanghai (CN); Chunhua Jiang, Shanghai (CN); Juan Feng, Shanghai (CN)

(21) Appl. No.: 19/004,552

(22) Filed: Dec. 30, 2024

(30) Foreign Application Priority Data
Dec. 28, 2023 (CN) 202311844081.9

(51) Int. Cl. G06T 7/33; G06T 3/02

(52) U.S. Cl. CPC G06T 7/337; G06T 3/02; G06T 2207/20021; G06T 2207/30101

(57) ABSTRACT

A method for correcting a digital subtraction angiography image is disclosed. The method includes: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area, to obtain a processed buffer area image; and fusing the second scan image, the third scan image, and the processed buffer area image to obtain a corrected scan image. A computer device and a non-volatile computer readable storage medium are also disclosed.

### CROSS-REFERENCE TO RELATED APPLICATIONS

The present application claims priority to Chinese patent application No. 202311844081.9, filed on Dec. 28, 2023, the entire content of which is incorporated herein by reference.

### TECHNICAL FIELD

The present disclosure relates to the field of digital subtraction angiography technologies, and in particular, to a method and device for correcting a digital subtraction angiography image, a computer device and a storage medium.

### BACKGROUND

Digital subtraction angiography (DSA) allows detailed visualization of blood vessels in the region of interest of the subject, and is usually used as a means of diagnosis and treatment of cerebrovascular and cardiovascular diseases. DSA technology performs X-ray film arrangement in the region of interest of a patient. First, an image without contrast agent is obtained as a mask, and then the contrast agent is applied to obtain a contrast image. There is a time difference between the mask and the contrast image. During the time difference, a human body will move to a certain extent, including spontaneous shaking of the body, breathing inside the body, and other movements. These movements will cause a large number of motion artifacts in the image.

In the related art, a registration method is usually adopted to correct a mask image once, and then a digital subtraction angiography image with motion artifacts removed is obtained. However, since some regions of interest have independent motion modes, registration of the entire image cannot achieve accurate correction of a local region of interest, which will result in low image accuracy of the region of interest of the digital subtraction angiography image.

Currently, no effective solution has been proposed for a problem of low image accuracy of the region of interest of the digital subtraction angiography image in the related art.

### SUMMARY

A first aspect of the present disclosure provides a method for correcting a digital subtraction angiography image. The method includes: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area, to obtain a processed buffer area image; and fusing the second scan image, the third scan image, and the processed buffer area image to obtain a corrected scan image.

In the first aspect of the present disclosure, the first scan image includes a first mask image. The second scan image includes a second mask image. The third scan image includes a third mask image. The reference image includes a contrast image. The corrected scan image includes a corrected mask image.

In the first aspect of the present disclosure, the first registration includes at least one of: translating and/or rotating the first mask image, performing an affine transformation on the first mask image, or performing an elastic registration on the first mask image and the contrast image.

In the first aspect of the present disclosure, the second registration includes at least one of: translating and/or rotating the second mask image, performing an affine transformation on the second mask image, or performing an elastic registration on the second mask image and the contrast image.

In the first aspect of the present disclosure, calculating the buffer area between the third scan image and the second scan image includes: calculating the buffer area between the third mask image and the second mask image based on an artifact degree of a boundary between the third mask image and the second mask image.

In the first aspect of the present disclosure, calculating the buffer area between the third scan image and the second scan image includes: calculating the buffer area between the third mask image and the second mask image based on a motion amplitude of the region of interest.

In the first aspect of the present disclosure, performing transition processing on the buffer area includes compressing or stretching positions of pixel points between an outer boundary of the buffer area and a boundary of the region of interest of the second scan image.

In the first aspect of the present disclosure, performing transition processing on the buffer area includes: acquiring matching point pairs of a plurality of pixel points in the buffer area before and after performing the second registration; and performing transition processing on the buffer area based on coordinates of the matching point pairs.

In the first aspect of the present disclosure, acquiring matching point pairs of the plurality of pixel points in the buffer area before and after performing the second registration includes: dividing the buffer area to obtain a plurality of sub-areas; and acquiring a matching point pair of a target point of a sub-area based on an offset of the target point of the sub-area after performing the second registration. The matching point pairs include the target point of the sub-area before performing the second registration and the target point of the sub-area after performing the second registration.

In the first aspect of the present disclosure, dividing the buffer area includes: dividing the buffer area into polygons. The sub-area includes a polygonal area.

In the first aspect of the present disclosure, performing transition processing on the buffer area based on the coordinates of the matching point pairs includes: calculating position coordinates of remaining pixel points in the buffer area based on the coordinates of the matching point pairs. Coordinate characteristics of the pixel points whose distance from the region of interest does not exceed a first preset value are approximate to coordinate characteristics of pixel points of the third mask image, and coordinate characteristics of the pixel points whose distance from the region of interest exceeds the first preset value are approximate to coordinate characteristics of pixel points of the contrast image.

In the first aspect of the present disclosure, fusing the second scan image, the third scan image, and the processed buffer area image to obtain the corrected scan image includes: stitching a part of the second mask image excluding the region of interest and the buffer area, the third mask image, and the processed buffer area image together to obtain the corrected mask image.

A second aspect of the present disclosure provides a computer device. The computer device includes a memory, a processor, and a computer program stored in the memory. The processor implements the following steps when executing the computer program: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area to obtain a processed buffer area image; and fusing the second scan image, the third scan image, and the processed buffer area image to obtain a corrected scan image.

In the second aspect of the present disclosure, the first scan image includes a first mask image. The second scan image includes a second mask image. The third scan image includes a third mask image. The reference image includes a contrast image. The corrected scan image includes a corrected mask image.

In the second aspect of the present disclosure, calculating the buffer area between the third scan image and the second scan image includes: calculating the buffer area between the third mask image and the second mask image based on an artifact degree of a boundary between the third mask image and the second mask image.

In the second aspect of the present disclosure, performing transition processing on the buffer area includes: acquiring matching point pairs of a plurality of pixel points in the buffer area before and after performing the second registration; and performing transition processing on the buffer area based on coordinates of the matching point pairs.

In the second aspect of the present disclosure, acquiring matching point pairs of the plurality of pixel points in the buffer area before and after performing the second registration includes: dividing the buffer area to obtain a plurality of sub-areas; and acquiring a matching point pair of a target point of a sub-area based on an offset of the target point of the sub-area after performing the second registration. The matching point pair includes the target point of the sub-area before performing the second registration and the target point of the sub-area after performing the second registration.

In the second aspect of the present disclosure, performing transition processing on the buffer area based on the coordinates of the matching point pairs includes: calculating position coordinates of remaining pixel points in the buffer area based on the coordinates of the matching point pairs. The coordinate characteristics of the pixel points whose distance from the region of interest does not exceed a first preset value are approximate to coordinate characteristics of pixel points of the third mask image, and coordinate characteristics of the pixel points whose distance from the region of interest exceeds the first preset value are approximate to coordinate characteristics of pixel points of the contrast image.

In the second aspect of the present disclosure, fusing the second scan image, the third scan image, and the processed buffer area image to obtain the corrected scan image includes: stitching a part of the second mask image excluding the region of interest and the buffer area, the third mask image, and the processed buffer area image together to obtain the corrected mask image.

A third aspect of the present disclosure further provides a non-volatile computer readable storage medium. The non-volatile computer readable storage medium stores a computer program. When the computer program is executed by a processor, the following steps are implemented: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area, to obtain a processed buffer area image; and fusing the second scan image, the third scan image, and the processed buffer area image to obtain a corrected scan image.

The details of one or more embodiments of the present disclosure are set forth in the following drawings and description. Other features, objects, and advantages of the present disclosure will become apparent from the description, drawings, and claims.

### BRIEF DESCRIPTION OF THE DRAWINGS

In order to describe the technical solutions in the embodiments of the present application or the conventional technology more clearly, the following will briefly introduce the accompanying drawings required for describing the embodiments or the conventional technology. Apparently, the accompanying drawings in the following description are merely embodiments of the present disclosure, and for a person of ordinary skill in the art, other drawings can be obtained based on the disclosed drawings without creative efforts.

FIG. 1 is a diagram illustrating an environment of a method for correcting a digital subtraction angiography image according to an embodiment of the present disclosure.

FIG. 2 is a flow diagram illustrating a method for correcting a digital subtraction angiography image according to an embodiment of the present disclosure.

FIG. 3 is a flow diagram illustrating a method for correcting a digital subtraction angiography image according to another embodiment of the present disclosure.

FIG. 4a is a schematic diagram illustrating area division of a method for correcting a digital subtraction angiography image according to an embodiment of the present disclosure.

FIG. 4b is a schematic diagram illustrating area division of a method for correcting a digital subtraction angiography image according to another embodiment of the present disclosure.

FIG. 5 is a flow diagram illustrating an overall process of a method for correcting a digital subtraction angiography image according to an embodiment of the present disclosure.

FIG. 6 is a structural block diagram illustrating a device for correcting a digital subtraction angiography image according to an embodiment of the present disclosure.

FIG. 7 is a diagram illustrating an internal configuration of a computer device according to an embodiment of the present disclosure.

### DETAILED DESCRIPTION OF THE EMBODIMENTS

The technical solutions in the embodiments of the present disclosure will be clearly and completely described with reference to the accompanying drawings. Apparently, the described embodiments are only some but not all of the embodiments of the present disclosure. Based on the embodiments of the present disclosure, all other embodiments obtained by a person of ordinary skill in the art without creative efforts shall fall within the protection scope of the present disclosure.

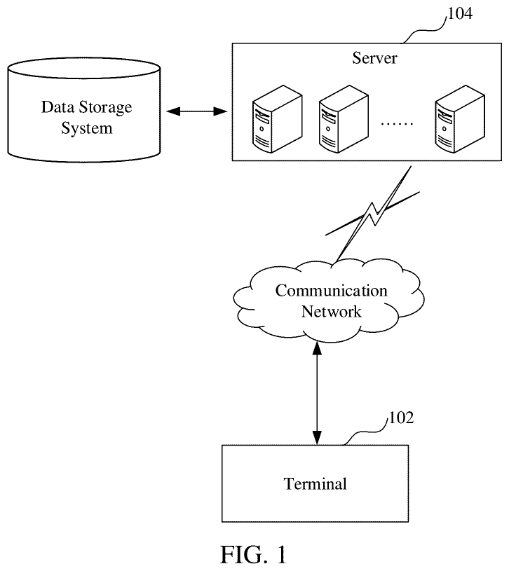

A method for correcting a digital subtraction angiography image provided in an embodiment of the present disclosure can be applied in the application environment shown in FIG. 1. A terminal 102 communicates with a server 104 through a network. A data storage system can store data that needs to be processed by the server 104. The data storage system can be integrated on the server 104, or can be placed on the cloud or other network servers. The terminal 102 may include, but is not limited to, various personal computers, laptops, smart phones, tablet computers, and the like. The server 104 may be implemented as a stand-alone server or a server cluster of a plurality of servers.

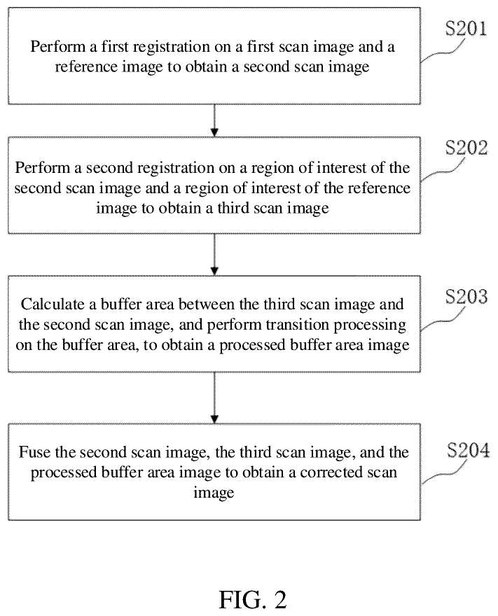

In an embodiment, as shown in FIG. 2, a method for correcting a digital subtraction angiography image is provided. The method includes the following steps of S201 to S204.

In step S201, a first registration is performed on a first scan image and a reference image to obtain a second scan image.

The first scan image can be an image obtained by photographing a target tissue before contrast agent is injected into a blood vessel, and the reference image can be an image obtained by photographing the target tissue after the contrast agent is injected into the blood vessel. Alternatively, the first scan image can be an image obtained by photographing a target tissue after the contrast agent is injected into a blood vessel, and the reference image can be an image obtained by photographing the target tissue before the contrast agent is injected into the blood vessel. The first registration refers to registering the first scan image as a whole based on the reference image, and a registered image is obtained as the second scan image. A first registration matrix is obtained by the first registration. The first registration matrix contains offsets corresponding to each of the pixel points of the first scan image. The first scan image is transformed according to the first registration matrix to obtain the second scan image, so that the second scan image is an image obtained after the first registration is completed.

In step S202, a second registration is performed on a region of interest of the second scan image and a region of interest of the reference image to obtain a third scan image.

The region of interest is a region that a user is concerned about. For example, the region of interest can be a region with motion, or a region with a suspected lesion. The region of interest can be obtained by automatic segmentation through an automatic segmentation algorithm, can be outlined by the user, or can be further modified by the user to be obtained based on an automatic segmentation result. In some embodiments, the second registration refers to choosing a more suitable registration algorithm to register the region of interest of the second scan image with the region of interest of the reference image to obtain a second registration matrix, based on characteristics of the region of interest, such as a movement mode of the region of interest. The second registration matrix contains offsets corresponding to each of the pixel points of the region of interest. The region of interest of the second scan image is transformed according to the second registration matrix to obtain the third scan image, so that the third scan image is a scan image of the region of interest obtained after the second registration is completed.

In step S203, a buffer area between the third scan image and the second scan image is calculated, and transition processing is performed on the buffer area, to obtain a processed buffer area image.

Since the second registration is to transform the region of interest of the second scan image and the region of interest of the reference image separately, artifacts may appear at a junction between the obtained scan image of the region of interest (i.e., the third scan image) and the complete scan image (i.e., the second scan image). The buffer area is an area where artifacts appear between the second scan image and the third scan image. In some embodiments, the buffer area surrounds a boundary of the region of interest of the second scan image and a boundary of the third scan image. Performing transition processing on the area means recalculating pixel points in the area to obtain a processed buffer area image, thereby eliminating artifacts in the buffer area. Performing transition processing on the buffer area includes compressing or stretching positions of the pixel points between an outer boundary of the buffer area and the boundary of the region of interest of the second scan image. In some embodiments, the positions of the pixel points between the outer boundary of the buffer area and the boundary of the region of interest of the second scan image can be translated to positions between the outer boundary of the buffer area and the boundary of the third scan image. The buffer area can be determined before the second registration of the region of interest is performed, or can be determined after the second registration of the region of interest is performed.

In step S204, the second scan image, the third scan image, and the processed buffer area image are fused to obtain a corrected scan image.

In the corrected scan image, the region of interest corresponds to the third scan image, the remaining regions correspond to the second scan image, and a boundary between the region of interest and the remaining regions corresponds to the buffer area image. For the scan image obtained by fusing, the corresponding registration is completed for the whole region and the region of interest, and there is no artifact at the junction (i.e., the buffer area) between the region of interest and the remaining regions.

In some examples, the reference image and the corrected scan image can be subtracted to obtain a subtraction image containing only blood vessels of the target tissue, eliminating artifacts in the subtraction image.

In the above method for correcting the digital subtraction angiography image, the first registration is performed on the first scan image and the reference image to obtain the second scan image. The second registration is performed on the region of interest of the second scan image and the region of interest of the reference image to obtain the third scan image. The buffer area between the third scan image and the second scan image is calculated, and the transition process is performed on the buffer area to obtain the processed buffer area image. The second scan image, the third scan image, and the processed buffer area image are fused to obtain the corrected scan image, thereby achieving accurate registration on the region of interest and ensuring that the region of interest which independently moves can be accurately corrected. In addition, the buffer area is set between the region of interest and the remaining regions to prevent artifacts from appearing at a boundary where the region of interest is adjacent to the remaining regions, thereby solving the problem of low image accuracy of the region of interest of the digital subtraction angiography image and improving accuracy of corrected image.

In an embodiment, the first scan image includes a first contrast image. The second scan image includes a second contrast image. The third scan image includes a third contrast image. The reference image includes a mask image. The corrected scan image includes a corrected contrast image. A method for correcting a digital subtraction angiography image includes: performing a first registration on a first contrast image and a mask image to obtain a second contrast image; performing a second registration on a region of interest of the second contrast image and a region of interest of the mask image to obtain a third contrast image; calculating a buffer area between the third contrast image and the second contrast image, and performing transition processing on the buffer area, to obtain a processed buffer area image; and fusing the second contrast image, the third contrast image, and the processed buffer area image to obtain a corrected contrast image.

The mask image refers to an image obtained by photographing a target tissue before contrast agent is injected into a blood vessel, and the contrast image refers to an image obtained by photographing the target tissue after the contrast agent is injected into the blood vessel. The first registration refers to registering the first contrast image as a whole based on the mask image, and a registered image is obtained as the second contrast image. The second registration refers to choosing a more suitable registration algorithm to register the region of interest of the second contrast image with the region of interest of the mask image based on characteristics of the region of interest, such as a movement mode of the region of interest. The third contrast image is a contrast image of the region of interest obtained after the second registration is completed. Since the second registration is to transform the region of interest of the second contrast image and the region of interest of the mask image separately, artifacts may appear at a junction between the obtained contrast image of the region of interest (i.e., the third contrast image) and the complete contrast image (i.e., the second contrast image). The buffer area is an area where artifacts appear between the second contrast image and the third contrast image. In some embodiments, the buffer area surrounds a boundary of the region of interest of the second contrast image and a boundary of the third contrast image. Performing transition processing on the area means recalculating pixel points in the area to obtain a processed buffer area image, thereby eliminating artifacts in the buffer area. Performing transition processing on the buffer area includes compressing or stretching positions of the pixel points between an outer boundary of the buffer area and the boundary of the region of interest of the second contrast image. In some embodiments, the positions of the pixel points between the outer boundary of the buffer area and the boundary of the region of interest of the second contrast image can be translated to positions between the outer boundary of the buffer area and the boundary of the third contrast image. In the corrected contrast image, the region of interest corresponds to the third contrast image, the remaining regions correspond to the second contrast image, and a boundary between the region of interest and the remaining regions corresponds to the buffer area image. For the contrast image obtained by fusing, the corresponding registration is completed for the whole region and the region of interest, and there is no artifact at the junction (i.e., the buffer area) between the region of interest and the remaining regions. In some examples, the mask image and the corrected contrast image can be subtracted to obtain a subtraction image containing only blood vessels of the target tissue, eliminating artifacts in the subtraction image.

In the above method for correcting the digital subtraction angiography image, the first registration is performed on the first contrast image and the mask image to obtain the second contrast image. The second registration is performed on the region of interest of the second contrast image and the region of interest of the mask image to obtain the third contrast image. The buffer area between the third contrast image and the second contrast image is calculated, and the transition process is performed on the buffer area to obtain the processed buffer area image. The second contrast image, the third contrast image, and the processed buffer area image are fused to obtain the corrected contrast image, thereby achieving accurate registration on the region of interest and ensuring that the region of interest which independently moves can be accurately corrected. In addition, the buffer area is set between the region of interest and the remaining regions to prevent artifacts from appearing at a boundary where the region of interest is adjacent to the remaining regions, thereby solving the problem of low image accuracy of the region of interest of the digital subtraction angiography image and improving accuracy of corrected image.

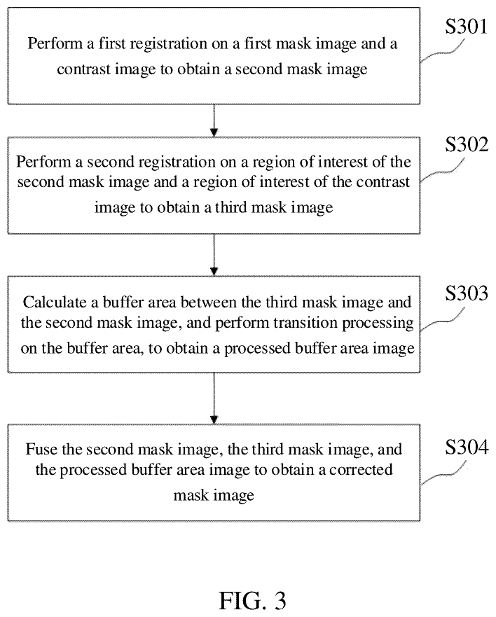

In an embodiment, the first scan image includes a first mask image. The second scan image includes a second mask image. The third scan image includes a third mask image. The reference image includes a contrast image. The corrected scan image includes a corrected mask image. as shown in FIG. 3, a method for correcting a digital subtraction angiography image is provided. The method includes the following steps of S301 to S304.

In step S301, a first registration is performed on a first mask image and a contrast image to obtain a second mask image.

The mask image refers to an image obtained by photographing a target tissue before contrast agent is injected into a blood vessel, and the contrast image refers to an image obtained by photographing the target tissue after the contrast agent is injected into the blood vessel. The first registration refers to registering the first mask image as a whole based on the contrast image, and a registered image is obtained as the second mask image.

In step S302, a second registration is performed on a region of interest of the second mask image and a region of interest of the contrast image to obtain a third mask image.

The region of interest is a region that a user is concerned about. For example, the region of interest can be a region with motion, or a region with a suspected lesion. The region of interest can be obtained by automatic segmentation through an automatic segmentation algorithm, can be outlined by the user, or can be further modified by the user to be obtained based on an automatic segmentation result. In some embodiments, the second registration refers to choosing a more suitable registration algorithm to register the region of interest of the second mask image with the region of interest of the contrast image based on characteristics of the region of interest, such as a movement mode of the region of interest. The third mask image is a mask image of the region of interest obtained after the second registration is completed.

In step S303, a buffer area between the third mask image and the second mask image is calculated, and transition processing is performed on the buffer area, to obtain a processed buffer area image.

Since the second registration is to transform the region of interest of the second mask image and the region of interest of the contrast image separately, artifacts may appear at a junction between the obtained mask image of the region of interest (i.e., the third mask image) and the complete mask image (i.e., the second mask image). The buffer area is an area where artifacts appear between the second mask image and the third mask image. In some embodiments, the buffer area surrounds a boundary of the region of interest of the second mask image and a boundary of the third mask image. Performing transition processing on the area means recalculating pixel points in the area to obtain a processed buffer area image, thereby eliminating artifacts in the buffer area. Performing transition processing on the buffer area includes compressing or stretching positions of the pixel points between an outer boundary of the buffer area and the boundary of the region of interest of the second mask image. In some embodiments, the positions of the pixel points between the outer boundary of the buffer area and the boundary of the region of interest of the second mask image can be translated to positions between the outer boundary of the buffer area and the boundary of the third mask image. The buffer area can be determined before the second registration of the region of interest is performed, or can be determined after the second registration of the region of interest is performed.

In step S304, the second mask image, the third mask image, and the processed buffer area image are fused to obtain a corrected mask image.

In the corrected mask image, the region of interest corresponds to the third mask image, the remaining regions correspond to the second mask image, and a boundary between the region of interest and the remaining regions corresponds to the buffer area image. For the mask image obtained by fusing, the corresponding registration is completed for the whole region and the region of interest, and there is no artifact at the junction (i.e., the buffer area) between the region of interest and the remaining regions.

In some examples, the contrast image and the corrected mask image can be subtracted to obtain a subtraction image containing only blood vessels of the target tissue, eliminating artifacts in the subtraction image.

In the above method for correcting the digital subtraction angiography image, the first registration is performed on the first mask image and the contrast image to obtain the second mask image. The second registration is performed on the region of interest of the second mask image and the region of interest of the contrast image to obtain the third mask image. The buffer area between the third mask image and the second mask image is calculated, and the transition process is performed on the buffer area to obtain the processed buffer area image. The second mask image, the third mask image, and the processed buffer area image are fused to obtain the corrected mask image, thereby achieving accurate registration on the region of interest and ensuring that the region of interest which independently moves can be accurately corrected. In addition, the buffer area is set between the region of interest and the remaining regions to prevent artifacts from appearing at a boundary where the region of interest is adjacent to the remaining regions, thereby solving the problem of low image accuracy of the region of interest of the digital subtraction angiography image and improving accuracy of corrected image. Moreover, taking the contrast image as a reference and performing the registration transformation on mask images can maximize the retention of the real information of blood vessels in the contrast image and ensure the accuracy of the subtraction image.

In an embodiment, the first registration and the second registration include at least one of: translating an image to be processed, performing affine transformation on the image to be processed, or performing an elastic registration on the image to be processed and the contrast image. The image to be processed includes the first mask image and the region of interest of the second mask image.

Specifically, the first registration includes at least one of: translating and/or rotating the first mask image, performing an affine transformation on the first mask image, or performing an elastic registration on the first mask image and the contrast image. The second registration includes at least one of: translating and/or rotating the second mask image, performing an affine transformation on the second mask image, or performing an elastic registration on the second mask image and the contrast image.

The first registration is used to register the whole of the first mask image with the whole of the contrast image, and the second registration is used to register the region of interest of the second mask image with the region of interest of the contrast image. When the first registration is performed, the image to be processed is the first mask image. When the second registration is performed, the image to be processed is the region of interest of the second mask image. Translating the image to be processed refers to translating the image to be processed to a position corresponding to the contrast image. Rotating the image to be processed refers to rotating the image to be processed to an angle corresponding to the contrast image. Performing the affine transformation on the image to be processed refers to performing the affine transformation (for example, linear transformation such as scaling and rotation) on the image to be processed based on a mapping relationship between the image to be processed and the contrast image. Performing an elastic registration on the image to be processed and the contrast image refers to deforming the image to be processed so that the deformed image to be processed is aligned with the contrast image.

In this embodiment, by performing many kinds of registrations on the image to be processed and the contrast image, comprehensive registration on the image to be processed and the contrast image is achieved, and accuracy of the digital subtraction angiography image registration is improved, thereby improving accuracy of the method for correcting the digital subtraction angiography image.

In an embodiment, calculating the buffer area between the third mask image and the second mask image includes: calculating the buffer area between the third mask image and the second mask image based on an artifact degree of a boundary between the third mask image and the second mask image.

The artifact degree refers to a deviation of a pixel value at the pixel point relative to a desired value of the pixel point. In some embodiments, a corresponding pixel point can be determined to belong to the buffer area based on the magnitude of the deviation of the pixel value relative to the desired value.

Specifically, the artifact degree can be determined based on the pixel value of the mask images. When the pixel value at a certain pixel point at the boundary between the third mask image and the second mask image is greater than the desired value, it indicates that the artifact degree of the pixel point is high, i.e., the pixel point belongs to the buffer area. When the pixel value at a certain pixel point at the boundary between the third mask image and the second mask image is less than or equal to the desired value, it indicates that the artifact degree of the pixel point is low, i.e., the pixel point does not belong to the buffer area.

In some embodiments, motion of the region of interest can also cause artifacts to appear at a boundary where the third mask image is adjacent to the second mask image, and thus the buffer area can be determined based on the motion magnitude of the region of interest. The motion magnitude of the region of interest can be greater than or equal to a motion magnitude between the region of interest of the second mask image and the region of interest of the contrast image. The buffer area covers at least an area between the boundary of the region of interest in the second mask image and the boundary of the region of interest in the contrast image. In some embodiments, the buffer area can be determined based on a maximum motion magnitude of the region of interest, so that the boundary of the region of interest of the second mask image and the boundary of the region of interest of the contrast image are contained by the buffer area.

In this embodiment, the buffer area is determined based on the artifact degree of the boundary between the third mask image and the second mask image, so as to avoid artifacts at the boundary between the third mask image and the second mask image and improve the accuracy of the corrected image.

Performing transition processing on the buffer area includes compressing or stretching positions of the pixel points between an outer boundary of the buffer area and the boundary of the region of interest of the second mask image. In some embodiments, the positions of the pixel points between the outer boundary of the buffer area and the boundary of the region of interest of the second mask image can be translated to positions between the outer boundary of the buffer area and the boundary of the third mask image. In an embodiment, performing transition processing on the buffer area includes: acquiring matching point pairs of a plurality of pixel points in the buffer area before and after performing the second registration; and performing transition processing on the buffer area based on coordinates of the matching point pairs.

In this embodiment, by acquiring the coordinates of the matching point pairs in the buffer area, other pixel points in the buffer area are processed, i.e., obtaining transformed coordinate values of the other of the pixel points in the buffer area, thereby improving calculation efficiency, realizing transition processing of pixel points in the buffer area, eliminating artifacts in the buffer area, and improving accuracy of digital subtraction angiography image correction.

In an embodiment, acquiring matching point pairs of the plurality of pixel points in the buffer area before and after performing the second registration includes: dividing the buffer area to obtain a plurality of sub-areas; and acquiring a matching point pair of a target point of a sub-area based on an offset of the target point of the sub-area after performing the second registration. The matching point pairs include the target point of the sub-area before performing the second registration and the target point of the sub-area after performing the second registration.

The sub-area includes a polygonal area, and the target point includes a vertex of the polygonal area. The sub-area may also be areas of other shapes, and each sub-area has the same shape. The target point may also be other feature points in the sub-area, such as a center point.

Specifically, the buffer area is divided into polygons to obtain a plurality of polygonal areas. Matching point pairs of vertices of the polygonal area are obtained based on offsets of vertices of the polygonal area after performing the second registration. The matching point pairs include vertices of the polygonal area before performing the second registration and the vertices of the polygonal area after performing the second registration. Transition processing is performed on the buffer area based on the coordinates of the matching point pairs.

Dividing the buffer area into polygons refers to dividing the buffer area into a plurality of identical polygons. A polygon may be any polygon, which is not limited in the present disclosure. Since the result obtained by triangular partition is smoother, and efficiency of calculation of the triangular partition and subsequent matching point is higher, the triangular partition is adopted to divide the buffer area in this embodiment. The offsets of the vertices of the polygonal area after performing the second registration can be obtained by the above mentioned second registration (for example, the offsets of the corresponding pixel points are obtained from the second registration matrix) or determined by calculating the coordinate differences of the vertices between the second mask image and the third mask image. The vertex of the polygonal area before performing the second registration can be represented by the vertex coordinates of the polygonal area in the second mask image, and the vertex of the polygonal area after performing the second registration can be represented by the vertex coordinates of the polygonal area in the third mask image. Performing transition processing on the buffer area refers to processing other pixel points in the buffer area based on the coordinates of the matching point pairs to eliminate the artifacts present in the buffer area.

In this embodiment, the buffer area is divided into polygons, matching point pairs are selected, and the coordinates of the matching point pairs is calculated. Other pixel points in the buffer area are processed based on the coordinates of the matching point pairs, thereby improving the calculation efficiency, realizing transition processing of pixel points in the buffer area, eliminating the artifacts in the buffer area, and improving the accuracy of digital subtraction angiography image correction.

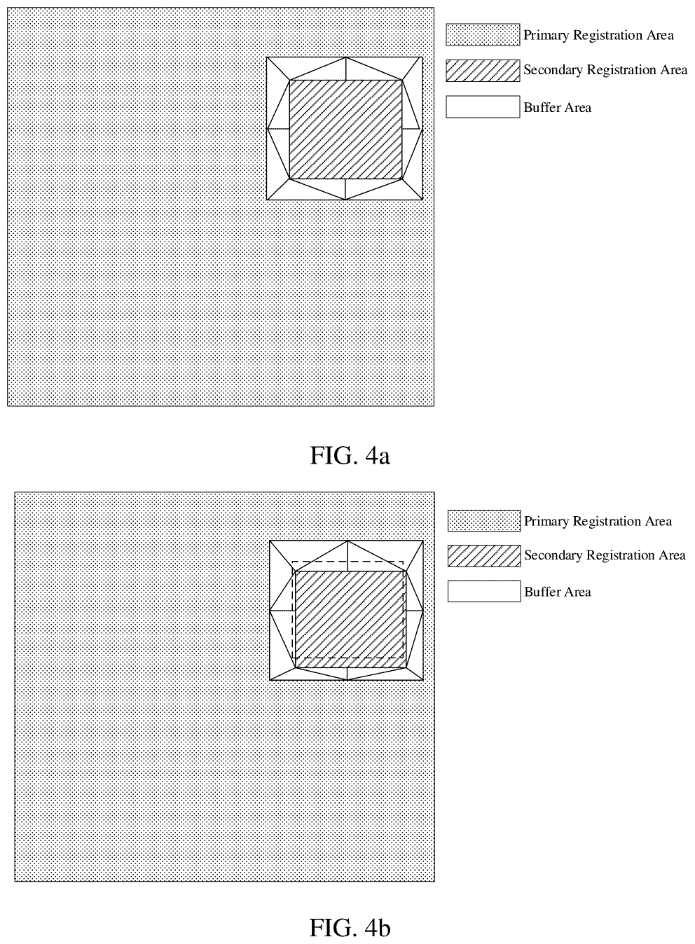

In an embodiment, performing transition processing on the buffer area based on the coordinates of the matching point pairs includes: calculating position coordinates of remaining pixel points in the buffer area based on the coordinates of the matching point pairs, so that each pixel in the buffer area maintains the original pixel value and the position is distributed from a boundary between the second mask image and the buffer area to a boundary between the third mask image and the buffer area, realizing a smooth transition of the pixel values at the boundaries and the elimination of artifacts. As shown in FIG. 4a and FIG. 4b, a primary registration area is an area other than the region of interest, and the second mask image includes the primary registration area. A secondary registration area is the region of interest, and the third mask image corresponds to the secondary registration area. As shown in FIG. 4b, taking the second registration as a translation for example, an area corresponding to the dashed line box can be the region of interest of the second mask image, which is translated to the secondary registration area by the second registration, and the image corresponding to the secondary registration area is the third mask image. Correspondingly, a part of the buffer area located on the upper side and the left side of the secondary registration area are stretched, a part of the buffer area located on the right side and the lower side of the secondary registration area are compressed, and the positions of the pixel points in the buffer area are distributed accordingly, i.e., the updated coordinates of the remaining pixel points in the buffer area can be obtained by calculating the coordinates of the matching point pairs. In the process of updating the coordinates of the remaining pixel points, the pixel values of the pixel points are kept as original pixel values. In some embodiments, the positions of the pixel points in the buffer area can be evenly distributed by interpolation. Coordinate characteristics of the pixel points whose distance from the region of interest does not exceed a first preset value are approximate to coordinate characteristics of pixel points of the third mask image, and coordinate characteristics of the pixel points whose distance from the region of interest exceeds the first preset value are approximate to coordinate characteristics of pixel points of the contrast image.

Taking the triangular partition of the buffer area as an example, FIG. 4a is a schematic diagram illustrating area division in the embodiment. As shown in FIG. 4a, a primary registration area is an area other than the region of interest, and the second mask image includes the primary registration area. A secondary registration area is the region of interest, and the third mask image corresponds to the secondary registration area. Before performing the second registration, coordinates of three vertices of a triangle are (x1, y1), (x2, y2), and (x3, y3). After performing the second registration, the coordinates of the three vertices of the triangle are (x1′, y1′), (x2′, y2′), and (x3′, y3′). Based on the coordinates of the vertices of the triangle, a specific method for calculating mapped coordinates (x′, y′) of a pixel point (x, y) in the buffer area is as follows:

$${x}^{′} = \frac{( x {2}^{′} - x {1}^{′} ) ( y 3 - y 1 ) - ( x {3}^{′} - x {1}^{′} ) ( y 2 - y 1 )}{( x 2 - x 1 ) ( y 3 - y 1 ) - ( x 3 - x 1 ) ( y 2 - y 1 )} \cdot x + \frac{( x {2}^{′} - x {1}^{′} ) ( x 3 - x 1 ) - ( x {3}^{′} - x {1}^{′} ) ( x 2 - x 1 )}{( y 2 - y 1 ) ( x 3 - x 1 ) - ( y 3 - y 1 ) ( x 2 - x 1 )} \cdot y + ( x {1}^{′} - \frac{( x {2}^{′} - x {1}^{′} ) ( y 3 - y 1 ) - ( x {3}^{′} - x {1}^{′} ) ( y 2 - y 1 )}{( x 2 - x 1 ) ( y 3 - y 1 ) - ( x 3 - x 1 ) ( y 2 - y 1 )} \cdot x 1 - \frac{( x {2}^{′} - x {1}^{′} ) ( x 3 - x 1 ) - ( x {3}^{′} - x {1}^{′} ) ( x 2 - x 1 )}{( y 2 - y 1 ) ( x 3 - x 1 ) - ( y 3 - y 1 ) ( x 2 - x 1 )} \cdot y 1 )$$

$${y}^{′} = \frac{( y {2}^{′} - y {1}^{′} ) ( x 3 - x 1 ) - ( y {3}^{′} - y {1}^{′} ) ( x 2 - x 1 )}{( y 2 - y 1 ) ( x 3 - x 1 ) - ( y 3 - y 1 ) ( x 2 - x 1 )} \cdot y + \frac{( y {2}^{′} - y {1}^{′} ) ( y 3 - y 1 ) - ( y {3}^{′} - y {1}^{′} ) ( y 2 - y 1 )}{( x 2 - x 1 ) ( y 3 - y 1 ) - ( x 3 - x 1 ) ( y 2 - y 1 )} \cdot x + ( y {1}^{′} - \frac{( y {2}^{′} - y {1}^{′} ) ( x 3 - x 1 ) - ( y {3}^{′} - y {1}^{′} ) ( x 2 - x 1 )}{( y 2 - y 1 ) ( x 3 - x 1 ) - ( y 3 - y 1 ) ( x 2 - x 1 )} \cdot y 1 - \frac{( y {2}^{′} - y {1}^{′} ) ( y 3 - y 1 ) - ( y {3}^{′} - y {1}^{′} ) ( y 2 - y 1 )}{( x 2 - x 1 ) ( y 3 - y 1 ) - ( x 3 - x 1 ) ( y 2 - y 1 )} \cdot x 1 )$$

The pixel points in the buffer area are traversed to calculate mapped coordinates of all the pixel points. The coordinates of the pixel points calculated by the above method have the following characteristics: characteristics of the pixel points closer to the secondary registration area (i.e., the distance from the region of interest does not exceed the first preset value) are closer to characteristics of the secondary registration area (third mask image), and characteristics of the pixel points closer to the primary registration area (i.e., the distance from the region of interest exceeds the first preset value) are closer to characteristics of the primary registration area (contrast image).

In this embodiment, the coordinates of the pixel points are adjusted based on distance between each pixel point in the buffer area and the region of interest. In case the buffer area is stretched or compressed, the buffer area can be interpolated accordingly, e.g. by bilinear interpolation, so that transition of the buffer area is smoother and more natural, thereby eliminating artifacts in the buffer area and improving the accuracy of image correction.

In an embodiment, fusing the second mask image, the third mask image, and the processed buffer area image to obtain the corrected mask image includes: stitching a part of the second mask image excluding the region of interest and the buffer area, the third mask image, and the processed buffer area image together to obtain the corrected mask image.

As shown in FIG. 4a, in the corrected mask image, the region of interest is an image of the secondary registration area (i.e., the third mask image), the buffer area is the buffer area image, and the other regions are images of the primary registration area (i.e., the second mask image).

In this embodiment, the corrected mask image is obtained by fusion, the region of interest is a mask image that has undergone the second registration, ensuring accurate correction of local region of interest. The buffer area reduces artifacts at the boundary between the region of interest and other parts, thereby improving image quality.

In an embodiment, before performing the first registration on the first mask image and the contrast image, the method further includes: performing preprocessing on the first mask image and the contrast image. The preprocessing includes at least one of: noise reduction processing, logarithmic transformation processing, normalization processing, or regularization processing.

The noise reduction process can reduce noise of an image and improve signal-to-noise ratio of the image. The logarithmic transformation process can transform an image from exponential domain to logarithmic domain to transform the image from the exponential domain to the linear domain, facilitating subsequent image processing. The normalization process and regularization process can correspond to image registration method to improve the accuracy of image registration and significantly improves registration effect.

In this embodiment, quality of the corrected image is improved by performing preprocessing on the first mask image and the contrast image before performing the first registration.

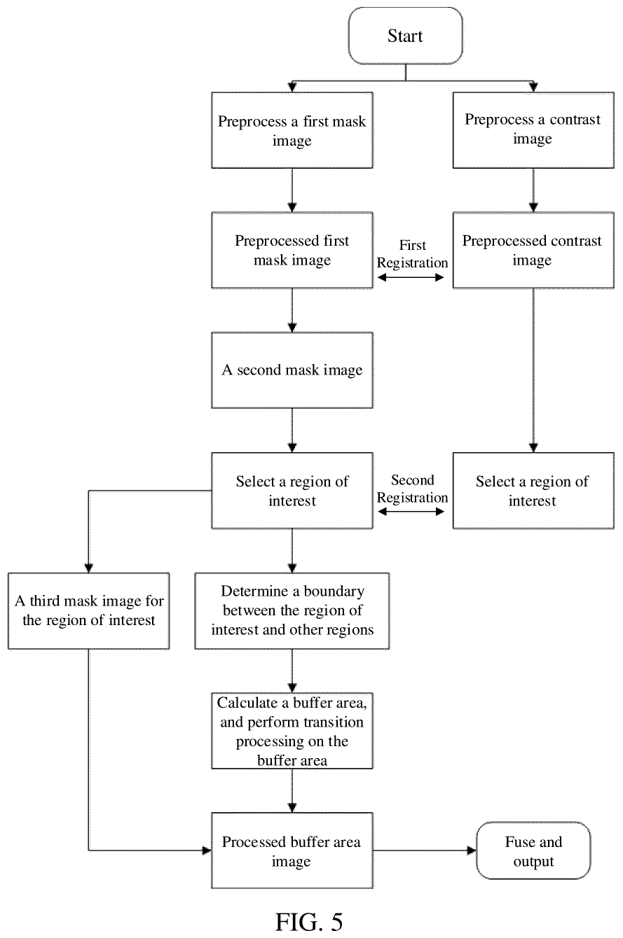

FIG. 5 is a schematic diagram illustrating an overall flow chart of a method for correcting a digital subtraction angiography image in an embodiment. As shown in FIG. 5, after starting, both a first mask image and a contrast image are preprocessed, and a first registration is performed on the preprocessed first mask image and the preprocessed contrast image to obtain a second mask image. A second registration is performed on a region of interest selected from the second mask image and a region of interest selected from the contrast image, to obtain a third mask image for the region of interest. The buffer area between the region of interest and the remaining regions is calculated. The buffer area can be determined before the second registration of the region of interest is performed, or can be determined after the second registration of the region of interest is performed. The buffer area is subjected to transition processing to eliminate artifacts of the buffer area. The processed buffer area image, the second mask image, and the third mask image are fused, so as to output a corrected mask image.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in this article, the execution of these steps does not have a strict order restriction, and these steps can be executed in other orders. Moreover, at least a part of the steps in the flowcharts involved in the above-mentioned embodiments can include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, an embodiment of the present disclosure also provides a device for correcting a digital subtraction angiography image, which can implement the method for correcting the digital subtraction angiography image described above. The implementation to solve the problem provided by the device is similar to the implementation described in the above method, so the specific limitations in one or more embodiments of the device for correcting the digital subtraction angiography image provided below can refer to the limitations of the above method for correcting the digital subtraction angiography image, and will not be repeated here.

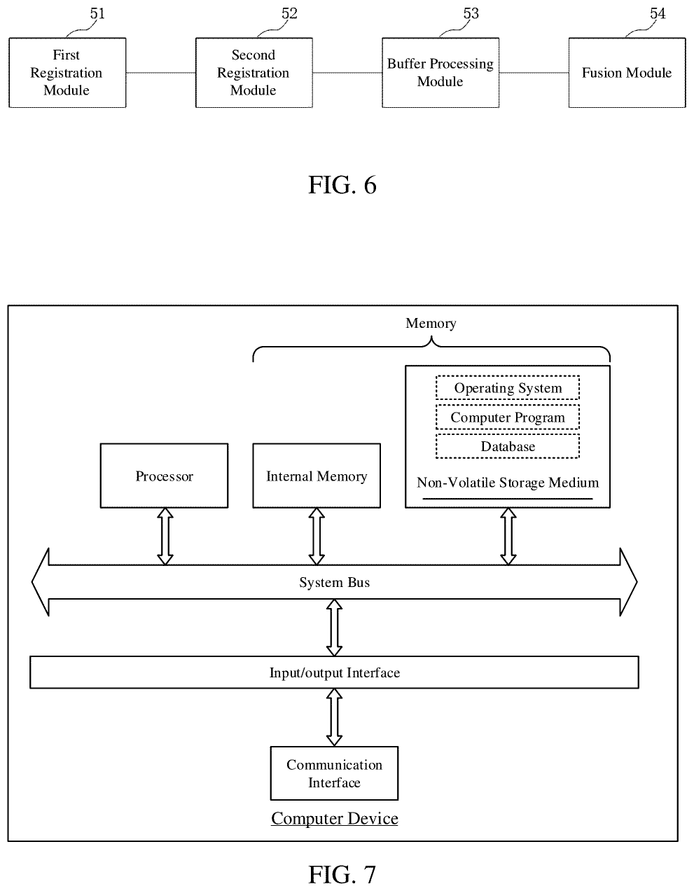

In an embodiment, as shown in FIG. 6, a device for correcting a digital subtraction angiography image is provided. The device includes a first registration module 51, a second registration module 52, a buffer processing module 53 and a fusion module 54. The first registration module 51 is configured to perform a first registration on the first scan image and the reference image to obtain a second scan image. The second registration module 52 is configured to perform a second registration on a region of interest of the second scan image and a region of interest of the reference image to obtain a third scan image. The buffer processing module 53 is configured to calculate the buffer area between the third scan image and the second scan image, and perform transition processing on the buffer area, to obtain a processed buffer area image. The fusion module 54 is configured to fuse the second scan image, the third scan image, and the processed buffer area image to obtain a corrected scan image.

The above-mentioned device for correcting the digital subtraction angiography image can be implemented in whole or in part by software, hardware and a combination thereof. Each of the above-mentioned modules can be embedded in or independent of a processor in a computer device in the form of hardware, or can be stored in a memory in a computer device in the form of software, so that the processor can call and execute the operations corresponding to each of the above modules.

In an embodiment, a computer device is provided, which may be a server. FIG. 7 illustrates an internal configuration of the computer device. The computer device includes a processor, a memory, an input/output (referred to as I/O) interface, and a communication interface. The processor, the memory and the input/output interface are connected via a system bus, and the communication interface is connected to the system bus via the input/output interface. The processor of the computer device is used to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device is used to store image data. The input/output interface of the computer device is used to exchange information between the processor and an external device. The communication interface of the computer device is used to communicate with an external terminal via a network connection. When the computer program is executed by the processor, a method for correcting a digital subtraction angiography image is implemented (For example, the above mentioned correction method of FIG. 2, FIG. 3 and FIG. 5).

Those skilled in the art will understand that the configuration shown in FIG. 7 is merely a block diagram of a partial configuration related to the solution of the present disclosure, and does not constitute a limitation on the computer device to which the solution of the present disclosure is applied. The specific computer device may include more or fewer components than shown in the figure, or combine certain components, or have a different arrangement of components.

In an embodiment, a computer device is provided. The computer device includes a memory and a processor, wherein a computer program is stored in the memory, and when the processor executes the computer program, the following steps are implemented: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area, to obtain a processed buffer area image; and fusing the second scan image, the third scan image, and the processed buffer area image to obtain a corrected scan image.

In an embodiment, the first scan image includes a first mask image. The second scan image includes a second mask image. The third scan image includes a third mask image. The reference image includes a contrast image. The corrected scan image includes a corrected mask image.

In an embodiment, the first scan image includes a first contrast image. The second scan image includes a second contrast image. The third scan image includes a third contrast image. The reference image includes a mask image. The corrected scan image includes a corrected contrast image.

In an embodiment, when the processor executes the computer program, at least one of the following steps are further implemented: translating and/or rotating the first mask image, performing an affine transformation on the first mask image, or performing an elastic registration on the first mask image and the contrast image.

In an embodiment, when the processor executes the computer program, at least one of the following steps are further implemented: translating and/or rotating the second mask image, performing an affine transformation on the second mask image, or performing an elastic registration on the second mask image and the contrast image.

In an embodiment, when the processor executes the computer program, the following steps are further implemented: calculating the buffer area between the third mask image and the second mask image based on an artifact degree of a boundary between the third mask image and the second mask image.

In an embodiment, when the processor executes the computer program, the following steps are further implemented: calculating the buffer area between the third mask image and the second mask image based on a motion amplitude of the region of interest.

In an embodiment, when the processor executes the computer program, the following steps are further implemented: acquiring matching point pairs of a plurality of pixel points in the buffer area before and after performing the second registration; and performing transition processing on the buffer area based on coordinates of the matching point pairs.

In an embodiment, when the processor executes the computer program, the following steps are further implemented: dividing the buffer area to obtain a plurality of sub-areas; and acquiring a matching point pair of a target point of a sub-area based on an offset of the target point of the sub-area after performing the second registration. The matching point pair includes the target point of the sub-area before performing the second registration and the target point of the sub-area after performing the second registration.

In an embodiment, when the processor executes the computer program, the following steps are further implemented: dividing the buffer area into polygons. The sub-area includes a polygonal area.

In an embodiment, the target point includes a vertex of the polygonal area.

In an embodiment, when the processor executes the computer program, the following steps are further implemented: calculating position coordinates of remaining pixel points in the buffer area based on the coordinates of the matching point pairs. Coordinate characteristics of the pixel points whose distance from the region of interest does not exceed a first preset value are approximate to coordinate characteristics of pixel points of the third mask image, and coordinate characteristics of the pixel points whose distance from the region of interest exceeds the first preset value are approximate to coordinate characteristics of pixel points of the contrast image.

In an embodiment, when the processor executes the computer program, the following steps are further implemented: stitching a part of the second mask image excluding the region of interest and the buffer area, the third mask image, and the processed buffer area image together to obtain the corrected mask image.

In an embodiment, when the processor executes the computer program, the following steps are further implemented: performing preprocessing on the first mask image and the contrast image. The preprocessing includes at least one of: noise reduction processing, logarithmic transformation processing, normalization processing, and regularization processing.

In an embodiment, a non-volatile computer readable storage medium is provided, on which a computer program is stored. When the computer program is executed by a processor, the following steps are implemented: performing a first registration on a first scan image and a reference image to obtain a second scan image; performing a second registration on a region of interest of the second scan image and a region of interest of the reference image to obtain a third scan image; calculating a buffer area between the third scan image and the second scan image, and performing transition processing on the buffer area, to obtain a processed buffer area image; and fusing the second scan image, the third scan image, and the processed buffer area image to obtain a corrected scan image.

In an embodiment, the first scan image includes a first mask image. The second scan image includes a second mask image. The third scan image includes a third mask image. The reference image includes a contrast image. The corrected scan image includes a corrected mask image.

In an embodiment, the first scan image includes a first contrast image. The second scan image includes a second contrast image. The third scan image includes a third contrast image. The reference image includes a mask image. The corrected scan image includes a corrected contrast image.

In an embodiment, when the computer program is executed by a processor, at least one of the following steps is further implemented: translating and/or rotating the first mask image, performing an affine transformation on the first mask image, or performing an elastic registration on the first mask image and the contrast image.

In an embodiment, when the computer program is executed by a processor, at least one of the following steps is further implemented: translating and/or rotating the second mask image, performing an affine transformation on the second mask image, or performing an elastic registration on the second mask image and the contrast image.

In an embodiment, when the computer program is executed by a processor, the following steps are further implemented: calculating the buffer area between the third mask image and the second mask image based on an artifact degree of a boundary between the third mask image and the second mask image.

In an embodiment, when the computer program is executed by a processor, the following steps are further implemented: calculating the buffer area between the third mask image and the second mask image based on a motion amplitude of the region of interest.

In an embodiment, when the computer program is executed by a processor, the following steps are further implemented: acquiring matching point pairs of a plurality of pixel points in the buffer area before and after performing the second registration; and performing transition processing on the buffer area based on coordinates of the matching point pairs.

In an embodiment, when the computer program is executed by a processor, the following steps are further implemented: dividing the buffer area to obtain a plurality of sub-areas; and acquiring a matching point pair of a target point of a sub-area based on an offset of the target point of the sub-area after performing the second registration. The matching point pair includes the target point of the sub-area before performing the second registration and the target point of the sub-area after performing the second registration.

In an embodiment, when the computer program is executed by a processor, the following steps are further implemented: dividing the buffer area into polygons. The sub-area includes a polygonal area.

In an embodiment, the target point includes a vertex of the polygonal area.

In an embodiment, when the computer program is executed by a processor, the following steps are further implemented: calculating position coordinates of remaining pixel points in the buffer area based on the coordinates of the matching point pairs. Coordinate characteristics of the pixel points whose distance from the region of interest does not exceed a first preset value are approximate to coordinate characteristics of pixel points of the third mask image, and coordinate characteristics of the pixel points whose distance from the region of interest exceeds the first preset value are approximate to coordinate characteristics of pixel points of the contrast image.

In an embodiment, when the computer program is executed by a processor, the following steps are further implemented: stitching a part of the second mask image excluding the region of interest and the buffer area, the third mask image, and the processed buffer area image together to obtain the corrected mask image.

In an embodiment, when the computer program is executed by a processor, the following steps are further implemented: performing preprocessing on the first mask image and the contrast image. The preprocessing includes at least one of: noise reduction processing, logarithmic transformation processing, normalization processing, and regularization processing.

It should be noted that the user information (including but not limited to user device information, user personal information, etc.) and data (including but not limited to data used for analysis, stored data, displayed data, etc.) involved in the present disclosure are those authorized by the user or sufficiently authorized by the parties. The collection, use and processing of the relevant data need to comply with the relevant laws, regulations and standards of the relevant countries and regions.

Those of ordinary skill in the art can understand that all or part of the processes in the methods of the above embodiments can be completed by instructing relevant hardware through a computer program. The computer program can be stored in a non-volatile computer-readable storage. In the media, when executed, the computer program may include the processes of the above method embodiments. Any reference to memory, database or other media used in the embodiments provided in the present disclosure may include at least one of non-volatile and volatile memory. Non-volatile memory can include read-only memory (ROM), magnetic tape, floppy disk, flash memory, optical memory, high-density embedded non-volatile memory, resistive memory (ReRAM), magnetoresistive random access memory (MRAM), ferroelectric random access memory (FRAM), phase change memory (PCM), graphene memory, etc. Volatile memory may include random access memory (RAM) or external cache memory, etc. By way of illustration and not limitation, RAM can be in many forms, such as static random access memory (SRAM) or dynamic random access memory (DRAM). The databases involved in the various embodiments provided in the present disclosure may include at least one of a relational database and a non-relational database. Non-relational databases may include blockchain-based distributed databases, etc., but are not limited thereto. The processors involved in the various embodiments provided in the present disclosure may be general-purpose processors, central processing units, graphics processors, digital signal processors, programmable logic devices, quantum computing-based data processing logic devices, etc., and are not limited to this.

The technical features of the above embodiments can be randomly combined. To simplify the description, not all possible combinations of the technical features in the above embodiments are described. However, as long as there is no contradiction in the combination of these technical features, all the combinations should be considered to be included within the scope of this specification.

The above-described embodiments only illustrate several embodiments of the present disclosure, and the descriptions of which are relatively specific and detailed, but should not be construed as limiting the scope of the patent disclosure. It should be noted that, for those of ordinary skill in the art, several modifications and improvements can be made without departing from the concept of the present disclosure, and these all fall within the protection scope of the present disclosure. Therefore, the protection scope of the present disclosure should be determined by the appended claims.

What is claimed is:

1. A method for correcting a digital subtraction angiography image, the method comprising:
performing a first registration on a first scan image and a reference image to obtain a second scan image;
performing a second registration on a region of interest of the second scan image and a region of interest of the reference image to obtain a third scan image;
calculating a buffer area between the third scan image and the second scan image, and performing transition processing on the buffer area, to obtain a processed buffer area image; and
fusing the second scan image, the third scan image, and the processed buffer area image to obtain a corrected scan image.

2. The method of claim 1, wherein the first scan image comprises a first mask image, the second scan image comprises a second mask image, the third scan image comprises a third mask image, the reference image comprises a contrast image, and the corrected scan image comprises a corrected mask image.

3. The method of claim 2, wherein the first registration comprises at least one of: translating and/or rotating the first mask image, performing an affine transformation on the first mask image, or performing an elastic registration on the first mask image and the contrast image.

4. The method of claim 2, wherein the second registration comprises at least one of: translating and/or rotating the second mask image, performing an affine transformation on the second mask image, or performing an elastic registration on the second mask image and the contrast image.

5. The method of claim 2, wherein calculating the buffer area between the third scan image and the second scan image comprises:
calculating the buffer area between the third mask image and the second mask image based on an artifact degree of a boundary between the third mask image and the second mask image.

6. The method of claim 2, wherein calculating the buffer area between the third scan image and the second scan image comprises:
calculating the buffer area between the third mask image and the second mask image based on a motion amplitude of the region of interest.

7. The method of claim 1, wherein performing transition processing on the buffer area comprises compressing or stretching positions of pixel points between an outer boundary of the buffer area and a boundary of the region of interest of the second scan image.

8. The method of claim 2, wherein performing transition processing on the buffer area comprises:
acquiring matching point pairs of a plurality of pixel points in the buffer area before and after performing the second registration; and
performing transition processing on the buffer area based on coordinates of the matching point pairs.

9. The method of claim 8, wherein acquiring matching point pairs of the plurality of pixel points in the buffer area before and after performing the second registration comprises:
dividing the buffer area to obtain a plurality of sub-areas; and
acquiring a matching point pair of a target point of a sub-area, based on an offset of the target point of the sub-area after performing the second registration, the matching point pair comprising the target point of the sub-area before performing the second registration and the target point of the sub-area after performing the second registration.

10. The method of claim 9, wherein dividing the buffer area comprises:
dividing the buffer area into polygons, the sub-area comprising a polygonal area.

11. The method of claim 8, wherein performing transition processing on the buffer area based on the coordinates of the matching point pairs comprises:
calculating position coordinates of remaining pixel points in the buffer area based on the coordinates of the matching point pairs, coordinate characteristics of the pixel points whose distance from the region of interest does not exceed a first preset value being approximate to coordinate characteristics of pixel points of the third mask image, and coordinate characteristics of the pixel points whose distance from the region of interest exceeds the first preset value being approximate to coordinate characteristics of pixel points of the contrast image.

12. The method of claim 2, wherein fusing the second scan image, the third scan image, and the processed buffer area image to obtain the corrected scan image comprises:
stitching a part of the second mask image excluding the region of interest and the buffer area, the third mask image, and the processed buffer area image together to obtain the corrected mask image.

13. A computer device comprising a memory, a processor, and a computer program stored in the memory and executable by the processor, wherein when the computer program is executed by the processor, the processor is caused to:
perform a first registration on a first scan image and a reference image to obtain a second scan image;
perform a second registration on a region of interest of the second scan image and a region of interest of the reference image to obtain a third scan image;
calculate a buffer area between the third scan image and the second scan image, and perform transition processing on the buffer area, to obtain a processed buffer area image; and
fuse the second scan image, the third scan image, and the processed buffer area image to obtain a corrected scan image.

14. The computer device of claim 13, wherein the first scan image comprises a first mask image, the second scan image comprises a second mask image, the third scan image comprises a third mask image, the reference image comprises a contrast image, and the corrected scan image comprises a corrected mask image.

15. The computer device of claim 14, wherein calculating the buffer area between the third scan image and the second scan image comprises:
calculating the buffer area between the third mask image and the second mask image based on an artifact degree of a boundary between the third mask image and the second mask image.

16. The computer device of claim 14, wherein performing transition processing on the buffer area comprises:
acquiring matching point pairs of a plurality of pixel points in the buffer area before and after performing the second registration; and
performing transition processing on the buffer area based on coordinates of the matching point pairs.

17. The computer device of claim 16, wherein acquiring matching point pairs of the plurality of pixel points in the buffer area before and after performing the second registration comprises:
dividing the buffer area to obtain a plurality of sub-areas; and
acquiring a matching point pair of a target point of a sub-area, based on an offset of the target point of the sub-area after performing the second registration, sub-area the matching point pair comprising the target point of the sub-area before performing the second registration and the target point of the sub-area after performing the second registration.

18. The computer device of claim 16, wherein performing transition processing on the buffer area based on the coordinates of the matching point pairs comprises:
calculating position coordinates of remaining pixel points in the buffer area based on the coordinates of the matching point pairs, coordinate characteristics of the pixel points whose distance from the region of interest does not exceed a first preset value being approximate to coordinate characteristics of pixel points of the third mask image, and the coordinate characteristics of the pixel points whose distance from the region of interest exceeds the first preset value being approximate to coordinate characteristics of pixel points of the contrast image.

19. The computer device of claim 14, wherein fusing the second scan image the third scan image, and the processed buffer area image to obtain the corrected scan image comprises:
stitching a part of the second mask image excluding the region of interest and the buffer area, the third mask image, and the processed buffer area image together to obtain the corrected mask image.

20. A non-volatile computer readable storage medium comprising a computer program stored thereon, wherein when the computer program is executed by a processor, the processor is caused to:
perform a first registration on a first scan image and a reference image to obtain a second scan image;
perform a second registration on a region of interest of the second scan image and a region of interest of the reference image to obtain a third scan image;
calculate a buffer area between the third scan image and the second scan image, and perform transition processing on the buffer area, to obtain a processed buffer area image; and
fuse the second scan image, the third scan image, and the processed buffer area image to obtain a corrected scan image.
